(19) United States
(12) Patent Application Publication
(10) Pub. No.: US 2024/0144191 A1
(43) Pub. Date: May 2, 2024

(54) GENERATING A SCHEDULE FOR A PICKER OF AN ONLINE CONCIERGE SYSTEM BASED ON AN EARNINGS GOAL AND AVAILABILITY INFORMATION

(71) Applicant: Maplebear Inc. (dba Instacart), San Francisco, CA (US)

(72) Inventors: Ganesh Krishnan, San Francisco, CA (US); Xiaofan Xu, Fremont, CA (US); Kevin Ryan, San Francisco, CA (US)

(21) Appl. No.: 17/977,759

(22) Filed: Oct. 31, 2022

(51) Int. Cl. G06Q 10/10

(52) U.S. Cl. CPC G06Q 10/1093

(57) ABSTRACT

An online concierge system receives a goal and availability information for a picker, in which the availability information describes time slot-location pairs for which the picker is available. The system accesses and applies a first and a second machine learning model to predict a likelihood that an order will be available for service and an amount of earnings for servicing the order, respectively, for each time slot-location pair. The system computes an estimated amount of earnings for each time slot-location pair based on the predictions and generates suggested schedules that each includes one or more time slot-location pairs. For each suggested schedule, the system computes a total estimated amount of earnings based on the estimated amount of earnings and one or more costs. The system identifies a suggested schedule for achieving the goal based on the total estimated amount of earnings or an estimated amount of time included in the suggested schedule.

### BACKGROUND

Online concierge systems allow customers to place online delivery orders and match the orders with pickers who flexibly service the orders at retailer locations on behalf of the customers. Pickers may service orders by performing different tasks involved in servicing the orders, such as driving to retailer locations, collecting items included in the orders, purchasing the items, and delivering the items to customers. Orders may be serviced by pickers for a variety of time slots and locations, and pickers may earn different amounts for servicing orders based on the time slots and locations of the orders they service. For example, during the busiest time of day, a picker may earn a relatively higher hourly rate for servicing orders in one location, while during the least busy time of day, a picker may earn a relatively lower hourly rate for servicing orders in a different location. Based on their availability, pickers may create their own flexible schedules for themselves to achieve their earnings goals (e.g., to maximize their earnings, to make a target amount in the least amount of time, etc.).

In some instances, however, pickers may become discouraged and may discontinue servicing orders (e.g., if they fail to achieve their earnings goals). For example, a picker who has relatively less experience or who often changes their own schedule might not be aware of which time slots or locations they should work to maximize their earnings. In this example, if the picker aims to earn a certain amount per hour but earns substantially less than they were hoping for, they may decide to discontinue servicing orders in connection with the online concierge system.

### SUMMARY

In accordance with one or more aspects of the disclosure, an online concierge system generates a suggested schedule for a picker of the online concierge system based on an earnings goal and availability information. More specifically, the online concierge system receives a goal associated with earnings for a picker and availability information for the picker, in which the availability information describes a set of time slot-location pairs and each time slot-location pair corresponds to a time slot and location for which the picker is available to service orders placed with the online concierge system. The online concierge system accesses and applies a first machine learning model to predict a likelihood that an order placed with the online concierge system will be available for the picker to service for each time slot-location pair. The online concierge system also accesses and applies a second machine learning model to predict an amount of earnings for the picker if the picker services an order placed with the online concierge system for each time slot-location pair. The online concierge system then computes an estimated amount of earnings for the picker for each time slot-location pair based on the predictions and generates a set of suggested schedules that each includes one or more time slot-location pairs of the set of time slot-location pairs. For each suggested schedule, the online concierge system computes a total estimated amount of earnings for the picker based on the estimated amount of earnings and one or more costs for the picker associated with a corresponding suggested schedule. The online concierge system identifies a suggested schedule for achieving the goal based on the total estimated amount of earnings or an estimated amount of time included in the suggested schedule and sends the suggested schedule to a picker client device associated with the picker.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for generating a suggested schedule for a picker of an online concierge system based on an earnings goal and availability information, in accordance with one or more embodiments.

FIGS. 4A-4E illustrate examples of a scheduling interface for generating a suggested schedule for a picker of an online concierge system based on an earnings goal and availability information, in accordance with one or more embodiments.

### DETAILED DESCRIPTION

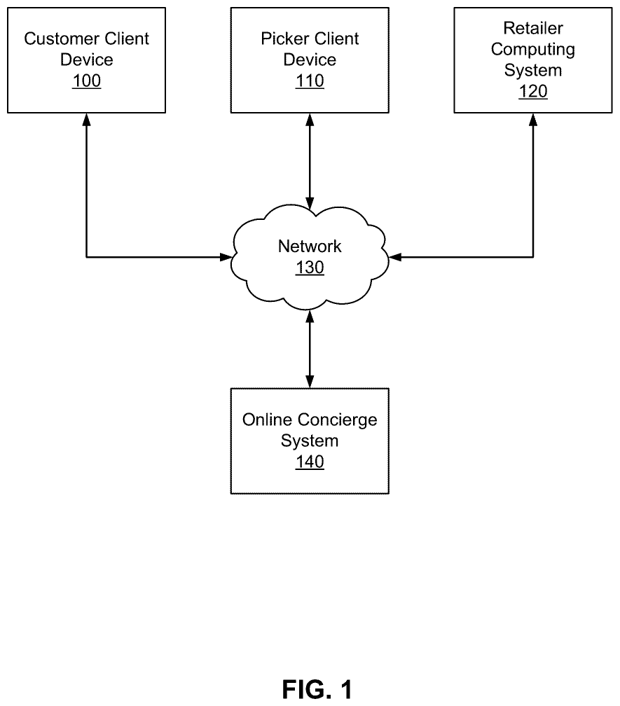

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the items should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

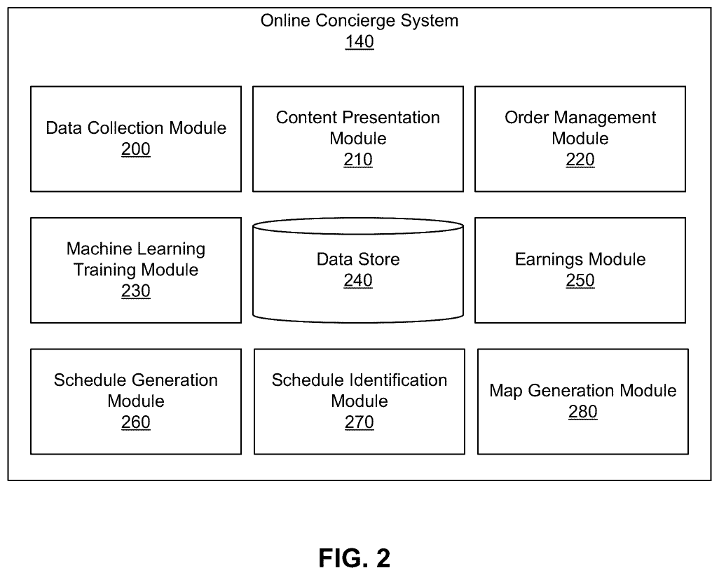

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, a data store 240, an earnings module 250, a schedule generation module 260, a schedule identification module 270, and a map generation module 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the items. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. As an additional example, the picker data for the picker may include information describing a vehicle operated by the picker, such as its make, model, year, vehicle type (e.g., gas, hybrid, electric, etc.), fuel type (e.g., regular, premium, diesel, etc.), fuel efficiency, and information describing a type of automobile insurance policy for the picker (e.g., pay-per-mile, traditional, etc.). Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In various embodiments, order data also may include an amount of earnings for a picker who serviced an order. An amount of earnings for a picker may include various components, such as a base pay rate, a tip amount, etc.

In some embodiments, order data also may include attributes of time slot-location pairs, in which a time slot-location pair corresponds to a combination of a particular time slot and a particular location for which orders may be placed with the online concierge system 140 and serviced. In various embodiments, the attributes for a time slot-location pair may describe the time slot (e.g., a time span during a time of the day, day of the week, etc.) or the location (e.g., one or more zip codes, cities, counties, etc.). Attributes of a time slot-location pair also may describe a demand side, a supply side, or supply gaps associated with the online concierge system 140 for the time slot-location pair, or any other suitable attributes of a time slot-location pair. For example, attributes of a time slot-location pair describing a demand side associated with the online concierge system 140 may include a number of orders placed by customers or a rate at which customers placed orders for the time slot-location pair, a number of items included in orders placed for the time slot-location pair, etc. As an additional example, attributes of a time slot-location pair describing a supply side associated with the online concierge system 140 may include a number of orders serviced by pickers or a rate at which pickers serviced orders for the time slot-location pair. As yet another example, attributes of a time slot-location pair describing a set of supply gaps associated with the online concierge system 140 may indicate whether less than a threshold number of orders were placed by customers or whether customers placed orders at less than a threshold rate for the time slot-location pair.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The content presentation module 210 also may present a scheduling interface for generating a suggested schedule for a picker based on information received from a picker client device 110 associated with the picker. The content presentation module 210 may receive information from the picker client device 110 via one or more interactive elements (e.g., radio buttons, text fields, drop-down menus, scroll bars, etc.) in the scheduling interface. Information received from the picker client device 110 via the scheduling interface may include a goal associated with earnings for the picker. Examples of goals associated with earnings for the picker include a maximized amount of earnings, a target amount of earnings, or any other suitable goal associated with earnings for a picker. For example, if the goal associated with earnings for the picker corresponds to a maximized amount of earnings, the goal indicates that the picker wants a schedule that will allow them to earn a maximum amount. As an additional example, if the goal associated with earnings for the picker corresponds to a target amount of earnings, the goal indicates that the picker wants a schedule that will allow them to earn at least a specific amount within a shortest amount of time.

In various embodiments, information received from the picker client device 110 via the scheduling interface also may include availability information for the picker. In such embodiments, availability information for the picker may describe a set of time slot-location pairs that each corresponds to a time slot and a location for which the picker is available to service orders placed with the online concierge system 140. Each time slot may correspond to a span of time (e.g., one hour, half an hour, etc.) during a particular time of the day and day of the week, while each location may correspond to one or more zip codes, cities, counties, etc. For example, availability information for a picker may indicate that the picker is available to service orders placed with the online concierge system 140 between 9:00 AM and 5:00 PM every weekend in the cities of Walnut Creek, Pleasant Hill, and Concord, and between 12:00 PM and 2:00 PM every weekday in the San Francisco Peninsula.

In various embodiments, the content presentation module 210 also may receive additional types of information from the picker client device 110 via the scheduling interface. Examples of such information include a starting location associated with the picker (e.g., a home location), a region including one or more locations for which the picker is available to service orders placed with the online concierge system 140, a request for the picker to build their own schedule, a request for the online concierge system 140 to generate a suggested schedule for the picker, a request to view an estimated or average earnings amount for pickers in a particular location, etc. For example, if the content presentation module 210 receives a request from the picker client device 110 for the online concierge system 140 to generate a suggested schedule for the picker, the content presentation module 210 subsequently may receive the availability information for the picker, the goal associated with earnings for the picker, and a starting location associated with the picker. As an additional example, if the content presentation module 210 receives a request from the picker client device 110 for the picker to build their own schedule, the content presentation module 210 subsequently may receive information identifying a region for which the picker is available to service orders placed with the online concierge system 140, availability information for the picker, and a starting location associated with the picker.

The content presentation module 210 also may send a suggested schedule to the picker client device 110 associated with the picker (e.g., via the scheduling interface). The suggested schedule may indicate the time slots for which the picker is or is not suggested to work, the locations and expected earnings for each time slot for which the picker is suggested to work, and any other suitable types of information. Additionally, the suggested schedule may be sent to the picker client device 110 in association with one or more estimated earnings for the picker (e.g., the picker's total estimated earnings, the picker's estimated earnings per hour, etc.). Furthermore, in some embodiments, the suggested schedule may be sent to the picker client device 110 in association with a map generated by the map generation module 280, as described below. In various embodiments, the suggested schedule or map may be updated based on one or more inputs received from the picker client device 110.

The order management module 220 manages orders for items from customers. The order management module 220 receives orders from a customer client device 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer who placed the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

In embodiments in which the earnings module 250 accesses an order availability model that is trained to predict a likelihood that an order placed with the online concierge system 140 will be available for a picker to service for a time slot-location pair, as described below, the machine learning training module 230 may train the order availability model. An order is available for a picker to service for a time slot-location pair if the picker may accept a request to service the order within a threshold amount of time of being presented with the order and the order is to be serviced during a time slot and at a location corresponding to the time slot-location pair. The machine learning training module 230 may train the order availability model via supervised learning based on order data describing orders previously placed with the online concierge system 140 stored in the data store 240. Order data used to train the order availability model may include attributes associated with multiple time slot-location pairs and a label for each time slot-location pair indicating whether an order placed with the online concierge system 140 was available for a picker to service for the corresponding time slot-location pair. For example, the machine learning training module 230 may receive a set of training examples including attributes of time slot-location pairs associated with orders previously placed with the online concierge system 140. In this example, the machine learning training module 230 also may receive a label for each time slot-location pair indicating whether an order placed with the online concierge system 140 was available for a picker to service for the corresponding time slot-location pair. Continuing with this example, the machine learning training module 230 may then train the order availability model based on the attributes of the time slot-location pairs and the label for each time slot-location pair by comparing its output from input data of each training example to the label for the training example. As described above, attributes of a time slot-location pair may describe the corresponding time slot or location, a demand side, a supply side, or supply gaps associated with the online concierge system 140 for the time slot-location pair, or any other suitable attributes of a time slot-location pair.

In embodiments in which the earnings module 250 accesses an earnings model that is trained to predict an amount of earnings for a picker if the picker services an order placed with the online concierge system 140 for a time slot-location pair, as described below, the machine learning training module 230 may train the earnings model. The machine learning training module 230 may train the earnings model via supervised learning based on order data describing orders serviced by pickers stored in the data store 240. Order data used to train the earnings model may include attributes associated with multiple time slot-location pairs and a label for each time slot-location pair indicating an amount of earnings for a picker who serviced an order placed with the online concierge system 140 for the corresponding time slot-location pair. For example, the machine learning training module 230 may receive a set of training examples including attributes of time slot-location pairs and a label for each time slot-location pair indicating an amount of earnings for a picker who serviced an order for the corresponding time slot-location pair. Continuing with this example, the machine learning training module 230 may then train the earnings model based on the attributes of the time slot-location pairs and the label for each time slot-location pair by comparing its output from input data of each training example to the label for the training example. As described above, attributes of a time slot-location pair may describe the corresponding time slot or location, a demand side, a supply side, or supply gaps associated with the online concierge system 140 for the time slot-location pair, or any other suitable attributes of a time slot-location pair.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

The earnings module 250 may access an order availability model that is trained to predict a likelihood that an order placed with the online concierge system 140 will be available for a picker to service for a time slot-location pair. The earnings module 250 may then apply the order availability model to predict the likelihood for each time slot-location pair included in a set of time slot-location pairs described by availability information for a picker. The order availability model may make the prediction based on various attributes associated with each time slot-location pair, such as attributes describing the corresponding time slot or location, attributes describing a demand side, a supply side, or a set of supply gaps associated with the online concierge system 140 for the corresponding time slot-location pair, etc. For example, if the content presentation module 210 has received availability information for a picker describing a set of time slot-location pairs, the earnings module 250 may access and apply the order availability model to a set of attributes of each time slot-location pair to predict a likelihood that an order placed with the online concierge system 140 will be available for the picker to service for the time slot-location pair.

The earnings module 250 also may access an earnings model that is trained to predict an amount of earnings for a picker if the picker services an order placed with the online concierge system 140 for a time slot-location pair. The earnings module 250 may then apply the earnings availability model to predict the amount of earnings for each time slot-location pair included in a set of time slot-location pairs described by availability information for a picker. The earnings model may make the prediction based on various attributes associated with each time slot-location pair, such as attributes describing the corresponding time slot or location, a number of orders placed by customers for the corresponding time slot-location pair, a number of items included in orders placed for the corresponding time slot-location pair, a rate at which orders were placed for the corresponding time slot-location pair, etc. For example, if the content presentation module 210 has received availability information for a picker describing a set of time slot-location pairs, the earnings module 250 may access and apply the earnings model to a set of attributes of each time slot-location pair to predict an amount of earnings for the picker if the picker services an order placed with the online concierge system 140 for the time slot-location pair.

For each time slot-location pair included in a set of time slot-location pairs described by availability information for a picker, the earnings module 250 also computes an estimated amount of earnings for the picker. The earnings module 250 may do so based on the predicted likelihood that an order placed with the online concierge system 140 will be available for the picker to service for the time slot-location pair and the predicted amount of earnings for the picker if the picker services an order placed with the online concierge system 140 for the time slot-location pair. In some embodiments, the estimated amount of earnings for the picker is computed by the earnings module 250 as a product of the predictions. For example, suppose that the order availability model predicts a 75% likelihood that an order placed with the online concierge system 140 will be available for the picker to service for a time slot-location pair and the earnings model predicts an hourly rate for the picker if the picker services an order placed with the online concierge system 140 for the time slot-location pair. In this example, the earnings module 250 may compute an estimated amount of earnings for the picker for the time slot-location pair to be 70% of that hourly rate.

For each suggested schedule generated by the schedule generation module 260, described below, the earnings module 250 also computes a total estimated amount of earnings for a picker. The earnings module 250 may compute the total estimated amount of earnings for the picker based on the estimated amount of earnings for each time slot-location pair included in a suggested schedule. For example, for a particular suggested schedule generated by the schedule generation module 260, the earnings module 250 may compute the total estimated amount of earnings for the picker as a sum of all the estimated amounts of earnings for all the time slot-location pairs included in the suggested schedule. In some embodiments, the earnings module 250 also may compute the total estimated amount of earnings for the picker based on one or more costs for the picker associated with a suggested schedule. In the above example, the earnings module 250 may compute the total estimated amount of earnings for the picker by subtracting one or more costs for the picker associated with the suggested schedule from the sum of the estimated amount of earnings for all the time slot-location pairs included in the suggested schedule.

In embodiments in which the earnings module 250 computes a total estimated amount of earnings for a picker based on one or more costs for the picker, the earnings module 250 may determine the one or more costs. Costs for a picker may be travel-related costs, such as fuel costs, toll costs, insurance costs, vehicle depreciation, travel time, or any other suitable costs that may be incurred by a picker while servicing orders. For example, for a particular suggested schedule, based on navigation instructions that may be provided by the online concierge system 140, the earnings module 250 may determine the costs of any tolls (e.g., for using toll roads, toll bridges, etc.) for a picker associated with the suggested schedule. As an additional example, for a particular suggested schedule, each time a picker is traveling to a different location, the earnings module 250 may determine a cost associated with a travel time of the picker during which the picker is not compensated. As yet another example, based on picker data for a picker (e.g., vehicle type, fuel type, and fuel efficiency) and information describing the average cost of fuel at gas stations in locations corresponding to a suggested schedule (e.g., from one or more websites, applications, or other third-party systems), the earnings module 250 may determine a cost of fuel for the picker for each mile traveled. In this example, for this suggested schedule, the earnings module 250 may compute the cost of fuel for the picker associated with the suggested schedule as a product of the number of miles the picker will likely travel based on the suggested schedule and the cost of fuel for each mile traveled. In the above example, if picker data for the picker also indicates that the picker's automobile insurance is a pay-per-mile policy, the earnings module 250 may compute the cost for the picker associated with the suggested schedule as a product of the number of miles the picker will likely travel based on the suggested schedule and the sum of the cost-per-mile charged by the policy and the cost of fuel for each mile traveled.

The schedule generation module 260 generates a set of suggested schedules from a set of time slot-location pairs described by availability information for a picker. Each suggested schedule may include one or more time slot-location pairs of the set of time slot-location pairs. In some embodiments, the set of suggested schedules generated from the set of time slot-location pairs described by the availability information for the picker may include every possible combination of suggested schedules. In other embodiments, the set of suggested schedules generated from the set of time slot-location pairs described by the availability information for the picker may only include some of the possible combinations of suggested schedules. In various embodiments, the set of suggested schedules may be generated using a technique or algorithm (e.g., a greedy partial enumeration algorithm) that excludes time slot-location pairs from the set of suggested schedules of suggested schedules that include the time slot-location pairs are unlikely to achieve a goal associated with earnings for the picker. For example, the schedule generation module 260 may identify one or more time slot-location pairs from the set of time slot-location pairs described by the availability information for the picker, in which the estimated amount of earnings associated with each of the identified time slot-location pairs is less than a threshold amount of earnings. In this example, the identified time slot-location pairs may be excluded from the set of suggested schedules generated by the schedule generation module 260.

When generating the set of suggested schedules from the set of time slot-location pairs described by the availability information for the picker, the schedule generation module 260 may take into account various factors. Examples of such factors include travel distances for different times of the day or days of the week, traffic conditions for different times of the day or days of the week, forecasted weather conditions, how busy retailer locations are likely to be on different times of the day or days of the week, a minimum length of time spent at each location, restrictions on switching to different locations within a threshold amount of time of a beginning or an end of a day, or any other suitable factors. For example, when generating a suggested schedule for the picker, the schedule generation module 260 may take into account travel times for the picker, such that the picker is able to travel from a first location associated with a time slot-location pair to a second location associated with another time slot-location pair and service orders in the corresponding locations during the corresponding time slots. In this example, the schedule generation module 260 may estimate the travel times for the picker based on the travel distance between the first and second locations, traffic conditions for the time of the day and day of the week corresponding to the time slots and locations, forecasted weather conditions for the corresponding time slots and locations, etc. In the above example, the schedule generation module 260 may also take into account an estimated amount of time required for the picker to service one or more orders at the locations based on how busy one or more retailer locations are likely to be on the time of the day and day of the week corresponding to the time slots and locations.

The schedule identification module 270 may identify, from a set of suggested schedules generated by the schedule generation module 260, a suggested schedule for achieving a goal associated with earnings for a picker. As described above, the goal associated with earnings for the picker may correspond to a maximized amount of earnings, a target amount of earnings, etc. The schedule identification module 270 may identify the suggested schedule for achieving the goal based on a total estimated amount of earnings for the picker computed by the earnings module 250 for each suggested schedule included among the set of suggested schedules. For example, if the goal associated with earnings for the picker corresponds to a maximized amount of earnings, the schedule identification module 270 may identify the suggested schedule for achieving the goal as the suggested schedule for which the earnings module 250 has computed the highest total estimated amount of earnings for the picker.

In some embodiments, the schedule identification module 270 also may identify the suggested schedule for achieving the goal associated with earnings for the picker based on additional factors. In various embodiments, the schedule identification module 270 also may identify the suggested schedule based on a number of time slots included in the suggested schedule. For example, if the goal associated with earnings for the picker corresponds to a target amount of earnings, the schedule identification module 270 may identify the suggested schedule for achieving the goal as the suggested schedule including the fewest number of time slots for which the earnings module 250 has computed a total estimated amount of earnings for the picker that is at least the target amount of earnings. In various embodiments, the schedule identification module 270 also may identify the suggested schedule based on a number of gaps in the suggested schedule. In the above example, the schedule identification module 270 alternatively may identify the suggested schedule for achieving the goal as the suggested schedule including the fewest number of contiguous time slots for which the earnings module 250 has computed a total estimated amount of earnings for the picker that is at least the target amount of earnings.

The map generation module 280 may generate a map indicating amounts of earnings associated with different locations depicted in the map. In various embodiments, the map generated by the map generation module 280 may correspond to a heat map, in which the amounts of earnings for different locations depicted in the heat map are represented visually (e.g., with different colors, shades, etc.). In some embodiments, the map generation module 280 may generate the map based on the estimated amount of earnings for each time slot-location pair computed by the earnings module 250. For example, based on information describing a time and a region including one or more locations for which a picker is available to service orders placed with the online concierge system 140 received from a picker client device 110 associated with the picker and the estimated amount of earnings for each time slot-location pair computed by the earnings module 250, the map generation module 280 may generate a heat map. In this example, locations associated with higher estimated amounts of earnings are shaded darker than locations associated with lower estimated amounts of earnings. Furthermore, in some embodiments, the heat map may be interactive. In the above example, the heat map may be updated to indicate the estimated amount of earnings for pickers in a location in response to receiving an interaction with the location within the heat map from the picker client device 110. In alternative embodiments, the heat map may be generated based on an average amount of earnings associated with each location depicted in the map. In the above example, based on order data stored in the data store 240 describing amounts of earnings for pickers who serviced orders placed with the online concierge system 140 for the corresponding time slot-location pairs, locations associated with higher average amounts of earnings are shaded darker than locations associated with lower average amounts of earnings.

### Generating a Suggested Schedule for a Picker of an Online Concierge System Based on an Earnings Goal and Availability Information

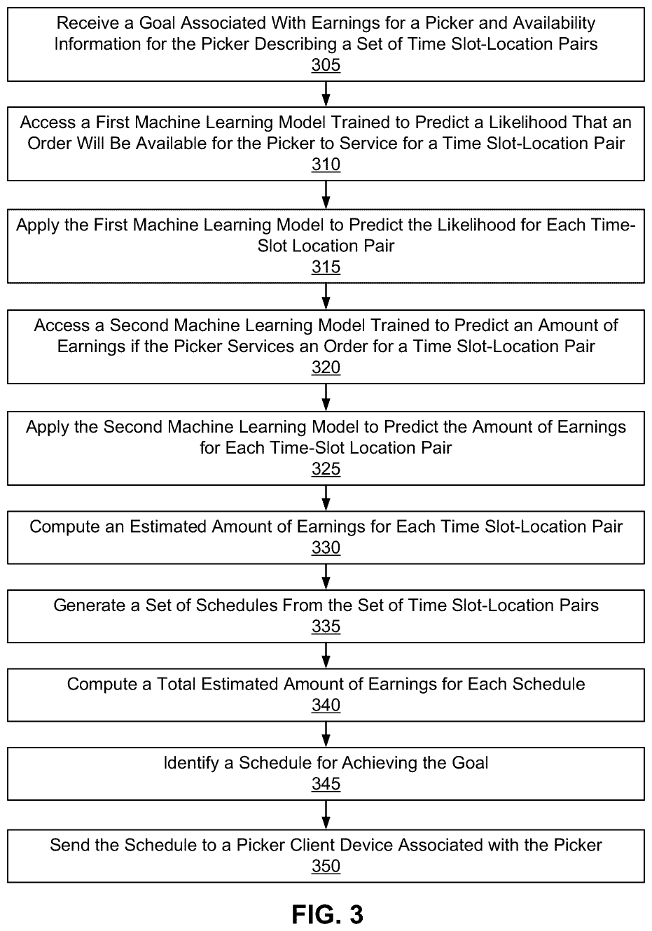

FIG. 3 is a flowchart of a method for generating a suggested schedule for a picker of an online concierge system based on an earnings goal and availability information, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system 140 receives 305 (e.g., via the content presentation module 210) a goal associated with earnings for a picker and availability information for the picker from a picker client device 110 associated with the picker. Examples of goals associated with earnings for the picker include a maximized amount of earnings, a target amount of earnings, or any other suitable goal associated with earnings for a picker. For example, if the goal associated with earnings for the picker corresponds to a maximized amount of earnings, the goal indicates that the picker wants a schedule that will allow them to earn a maximum amount. As an additional example, if the goal associated with earnings for the picker corresponds to a target amount of earnings, the goal indicates that the picker wants a schedule that will allow them to earn at least a specific amount within a shortest amount of time. The availability information for the picker may describe a set of time slot-location pairs that each corresponds to a time slot and a location for which the picker is available to service orders placed with the online concierge system 140. Each time slot may correspond to a span of time (e.g., one hour, half an hour, etc.) during a particular time of the day and day of the week, while each location may correspond to one or more zip codes, cities, counties, etc. For example, availability information for a picker may indicate that the picker is available to service orders placed with the online concierge system 140 between 9:00 AM and 5:00 PM every weekend in the cities of Walnut Creek, Pleasant Hill, and Concord, and between 12:00 PM and 2:00 PM every weekday in the San Francisco Peninsula.

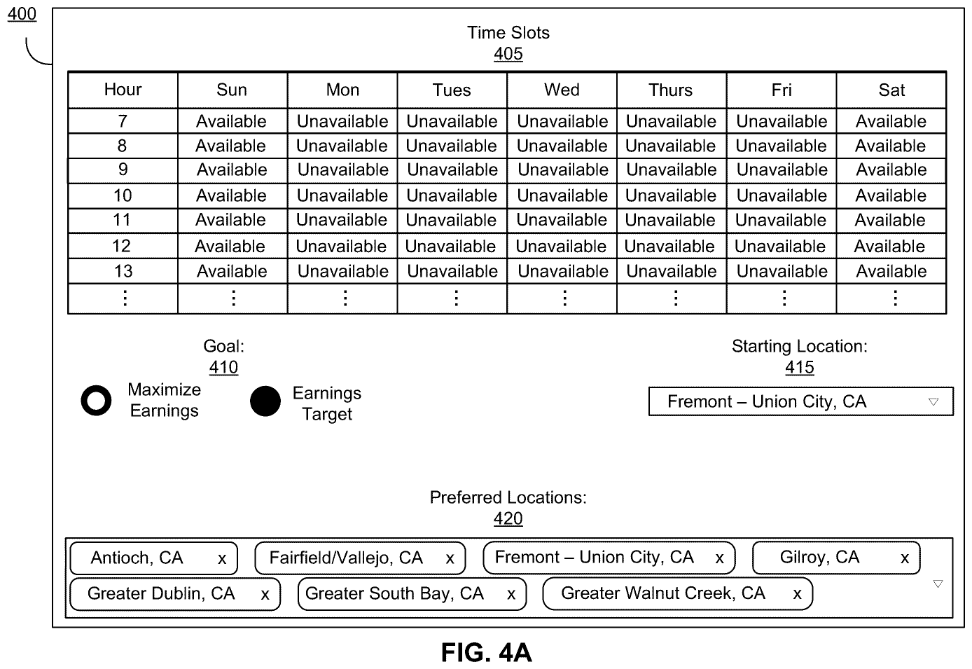

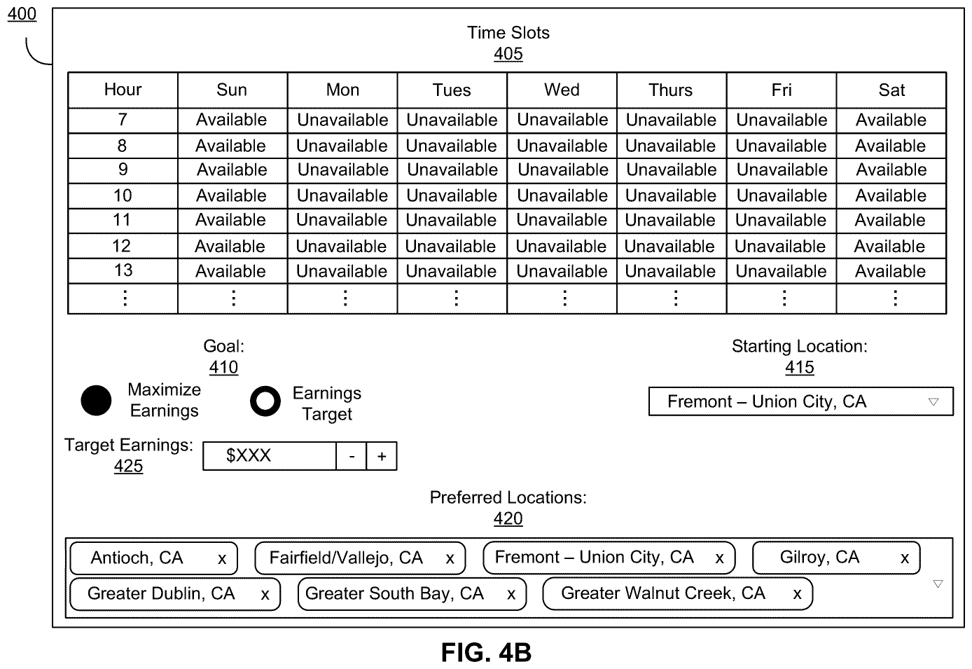

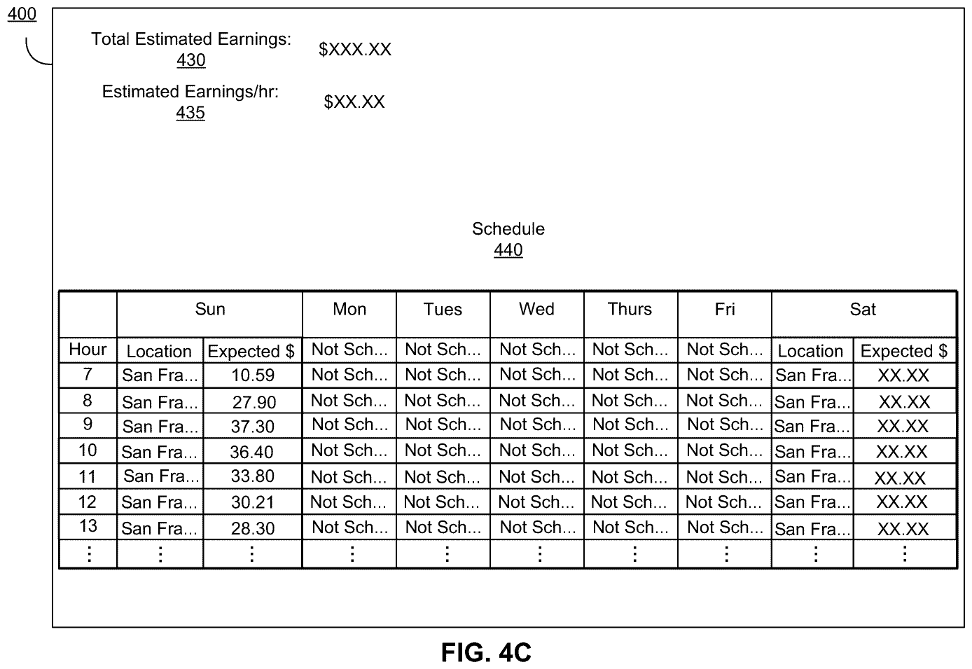

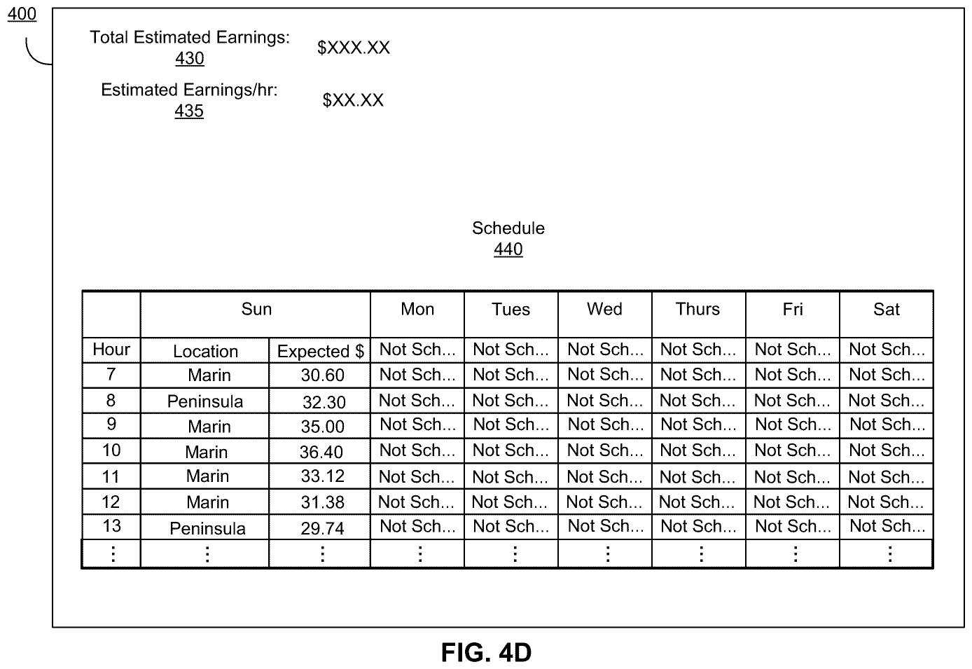

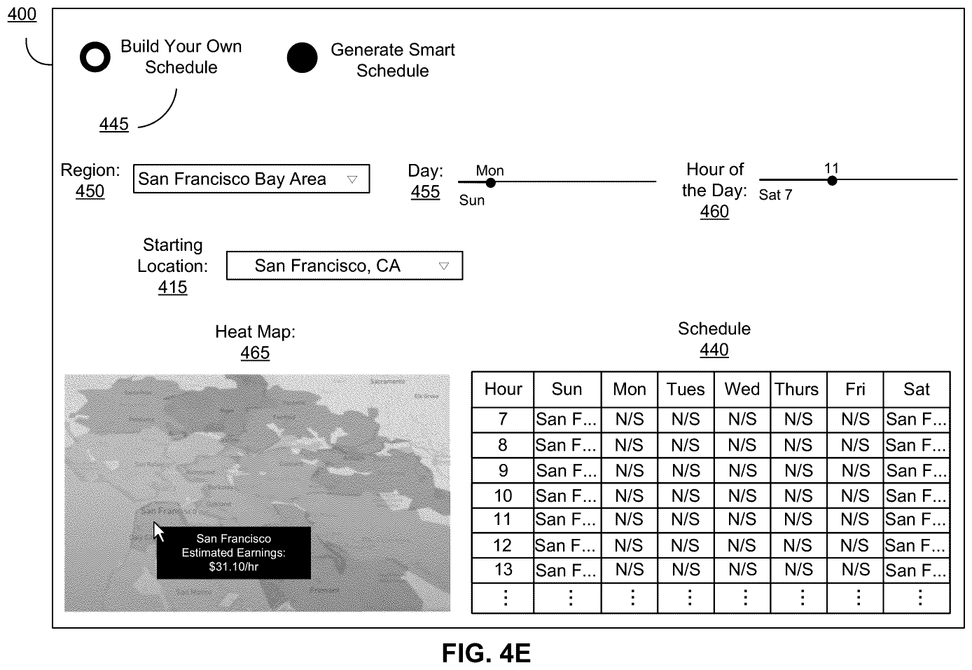

The online concierge system 140 may receive 305 the goal associated with earnings for the picker and the availability information for the picker via one or more interactive elements (e.g., radio buttons, text fields, drop-down menus, scroll bars, etc.) included in a scheduling interface for generating a suggested schedule for the picker. In various embodiments, the online concierge system 140 also may receive additional types of information from the picker client device 110 via the scheduling interface. Examples of such information include a starting location associated with the picker (e.g., a home location), a region including one or more locations for which the picker is available to service orders placed with the online concierge system 140, a request for the picker to build their own schedule, a request for the online concierge system 140 to generate a suggested schedule for the picker, a request to view an estimated or average earnings amount for pickers in a particular location, etc. FIGS. 4A-4E illustrate examples of a scheduling interface 400 for generating a suggested schedule for a picker of an online concierge system 140 based on an earnings goal 410 and availability information, in accordance with one or more embodiments. Referring to FIG. 4A, suppose that the online concierge system 140 receives a request from the picker client device 110 for the online concierge system 140 to generate a suggested schedule for the picker. Continuing with this example, the online concierge system 140 subsequently may receive 305 the availability information for the picker describing various time slots 405 on Sunday and Saturday and the picker's preferred locations 420 of Antioch, CA, Fairfield/Vallejo, CA, etc., as well as the goal 410 associated with earnings for the picker, indicating that the picker wants to maximize their earnings. Furthermore, in this example, the online concierge system 140 also receives a starting location 415 of Fremont—Union City, CA associated with the picker. Alternatively, as shown in the example of FIG. 4B, if the goal 410 associated with the earnings or the picker is to achieve an earnings target, the online concierge system 140 also may receive 305 information describing the earnings target 425.

Referring back to FIG. 3, the online concierge system 140 then accesses 310 (e.g., using the earnings module 250) an order availability model that is trained to predict a likelihood that an order placed with the online concierge system 140 will be available for the picker to service for a time slot-location pair. The online concierge system 140 also applies 315 (e.g., using the earnings module 250) the order availability model to predict the likelihood for each time slot-location pair included in the set of time slot-location pairs described by the availability information for the picker. The order availability model may make the prediction based on various attributes associated with each time slot-location pair, such as attributes describing the corresponding time slot 405 or location 420, attributes describing a demand side, a supply side, or a set of supply gaps associated with the online concierge system 140 for the corresponding time slot-location pair, etc. For example, the online concierge system 140 may access 310 and apply 315 the order availability model to a set of attributes of each time slot-location pair to predict a likelihood that an order placed with the online concierge system 140 will be available for the picker to service for the time slot-location pair. In some embodiments, the order availability model may be trained by the online concierge system 140 (e.g., using the machine learning training module 230, as described above).

The online concierge system 140 then accesses 320 (e.g., using the earnings module 250) an earnings model that is trained to predict an amount of earnings for the picker if the picker services an order placed with the online concierge system 140 for a time slot-location pair. The online concierge system 140 also applies 325 (e.g., using the earnings module 250) the earnings availability model to predict the amount of earnings for each time slot-location pair included in the set of time slot-location pairs described by the availability information for the picker. The earnings model may make the prediction based on various attributes associated with each time slot-location pair, such as attributes describing the corresponding time slot 405 or location 420, a number of orders placed by customers for the corresponding time slot-location pair, a number of items included in orders placed for the corresponding time slot-location pair, a rate at which orders were placed for the corresponding time slot-location pair, etc. For example, the online concierge system 140 may access 320 and apply 325 the earnings model to a set of attributes of each time slot-location pair to predict an amount of earnings for the picker if the picker services an order placed with the online concierge system 140 for the time slot-location pair. In some embodiments, the earnings model may be trained by the online concierge system 140 (e.g., using the machine learning training module 230, as described above).

For each time slot-location pair included in the set of time slot-location pairs described by the availability information for the picker, the online concierge system 140 computes 330 (e.g., using the earnings module 250) an estimated amount of earnings for the picker. The online concierge system 140 may do so based on the predicted likelihood that an order placed with the online concierge system 140 will be available for the picker to service for the time slot-location pair and the predicted amount of earnings for the picker if the picker services an order placed with the online concierge system 140 for the time slot-location pair. In some embodiments, the estimated amount of earnings for the picker is computed 330 by the online concierge system 140 as a product of the predictions. For example, suppose that the order availability model predicts a 75% likelihood that an order placed with the online concierge system 140 will be available for the picker to service for a time slot-location pair and the earnings model predicts an hourly rate for the picker if the picker services an order placed with the online concierge system 140 for the time slot-location pair. In this example, the online concierge system 140 may compute 330 an estimated amount of earnings for the picker for the time slot-location pair to be 75% of that hourly rate.

The online concierge system 140 then generates 335 (e.g., using the schedule generation module 260) a set of suggested schedules from the set of time slot-location pairs described by the availability information for the picker. Each suggested schedule may include one or more time slot-location pairs of the set of time slot-location pairs. In some embodiments, the set of suggested schedules generated 335 from the set of time slot-location pairs described by the availability information for the picker may include every possible combination of suggested schedules. In other embodiments, the set of suggested schedules generated 335 from the set of time slot-location pairs described by the availability information for the picker may only include some of the possible combinations of suggested schedules. In various embodiments, the set of suggested schedules may be generated 335 using a technique or algorithm (e.g., a greedy partial enumeration algorithm) that excludes time slot-location pairs from the set of suggested schedules if suggested schedules that include the time slot-location pairs are unlikely to achieve the goal 410 associated with earnings for the picker. For example, the online concierge system 140 may identify one or more time slot-location pairs from the set of time slot-location pairs described by the availability information for the picker, in which the estimated amount of earnings associated with each of the identified time slot-location pairs is less than a threshold amount of earnings. In this example, the identified time slot-location pairs may be excluded from the set of suggested schedules generated 335 by the online concierge system 140.

When generating 335 the set of suggested schedules from the set of time slot-location pairs described by the availability information for the picker, the online concierge system 140 may take into account various factors. Examples of such factors include travel distances for different times of the day or days of the week, traffic conditions for different times of the day or days of the week, forecasted weather conditions, how busy retailer locations are likely to be on different times of the day or days of the week, a minimum length of time spent at each location, restrictions on switching to different locations within a threshold amount of time of a beginning or an end of a day, or any other suitable factors. For example, when generating 335 a suggested schedule for the picker, the online concierge system 140 may take into account travel times for the picker, such that the picker is able to travel from a first location 420 associated with a time slot-location pair to a second location 420 associated with another time slot-location pair and service orders in the corresponding locations 420 during the corresponding time slots 405. In this example, the online concierge system 140 may estimate the travel times for the picker based on the travel distance between the first and second locations 420, traffic conditions for the time of the day and day of the week corresponding to the time slots 405 and locations 420, forecasted weather conditions for the corresponding time slots 405 and locations 420, etc. In the above example, the online concierge system 140 may also take into account an estimated amount of time required for the picker to service one or more orders at the locations 420 based on how busy one or more retailer locations are likely to be on the time of the day and day of the week corresponding to the time slots 405 and locations 420.

For each suggested schedule, the online concierge system 140 computes 340 (e.g., using the earnings module 250) a total estimated amount of earnings for the picker. The online concierge system 140 may compute 340 the total estimated amount of earnings for the picker based on the estimated amount of earnings for each time slot-location pair included in a suggested schedule. For example, for a particular suggested schedule, the online concierge system 140 may compute 340 the total estimated amount of earnings for the picker as a sum of all the estimated amounts of earnings for all the time slot-location pairs included in the suggested schedule. In some embodiments, the online concierge system 140 also may compute 340 the total estimated amount of earnings for the picker based on one or more costs for the picker associated with a suggested schedule. In the above example, the online concierge system 140 may compute 340 the total estimated amount of earnings for the picker by subtracting one or more costs for the picker associated with the suggested schedule from the sum of the estimated amount of earnings for all the time slot-location pairs included in the suggested schedule.

In embodiments in which the online concierge system 140 computes 340 the total estimated amount of earnings for the picker based on one or more costs for the picker, the online concierge system 140 may determine (e.g., using the earnings module 250) the one or more costs. Costs for the picker may be travel-related costs, such as fuel costs, toll costs, insurance costs, vehicle depreciation, travel time, or any other suitable costs that may be incurred by a picker while servicing orders. For example, for a particular suggested schedule, based on navigation instructions that may be provided by the online concierge system 140, the online concierge system 140 may determine the costs of any tolls (e.g., for using toll roads, toll bridges, etc.) for the picker associated with the suggested schedule. As an additional example, for a particular suggested schedule, each time the picker is traveling to a different location 420, the online concierge system 140 may determine a cost associated with a travel time of the picker during which the picker is not compensated. As yet another example, based on picker data for the picker (e.g., vehicle type, fuel type, and fuel efficiency) and information describing the average cost of fuel at gas stations in locations 420 corresponding to a suggested schedule (e.g., from one or more websites, applications, or other third-party systems), the online concierge system 140 may determine a cost of fuel for the picker for each mile traveled. In this example, for this suggested schedule, the online concierge system 140 may compute the cost of fuel for the picker associated with the suggested schedule as a product of the number of miles the picker will likely travel based on the suggested schedule and the cost of fuel for each mile traveled. In the above example, if picker data for the picker also indicates that the picker's automobile insurance is a pay-per-mile policy, the online concierge system 140 may compute the cost for the picker associated with the suggested schedule as a product of the number of miles the picker will likely travel based on the suggested schedule and the sum of the cost-per-mile charged by the policy and the cost of fuel for each mile traveled.

The online concierge system 140 then identifies 345 (e.g., using the schedule identification module 270), from the set of suggested schedules generated 335 by the online concierge system 140, a suggested schedule for achieving the goal 410 associated with earnings for the picker. As described above, the goal 410 associated with earnings for the picker may correspond to a maximized amount of earnings, a target amount of earnings, etc. The online concierge system 140 may identify 345 the suggested schedule for achieving the goal 410 based on the total estimated amount of earnings for the picker computed 340 by the online concierge system 140 for each suggested schedule included among the set of suggested schedules. For example, if the goal 410 associated with earnings for the picker corresponds to a maximized amount of earnings, the online concierge system 140 may identify 345 the suggested schedule for achieving the goal 410 as the suggested schedule for which the online concierge system 140 has computed 340 the highest total estimated amount of earnings for the picker.

In some embodiments, the online concierge system 140 also may identify 345 the suggested schedule for achieving the goal 410 associated with earnings for the picker based on additional factors. In various embodiments, the online concierge system 140 also may identify 345 the suggested schedule based on a number of time slots 405 included in the suggested schedule. For example, if the goal 410 associated with earnings for the picker corresponds to a target amount of earnings, the online concierge system 140 may identify 345 the suggested schedule for achieving the goal 410 as the suggested schedule including the fewest number of time slots 405 for which the online concierge system 140 has computed 340 a total estimated amount of earnings for the picker that is at least the target amount of earnings. In various embodiments, the online concierge system 140 also may identify 345 the suggested schedule based on a number of gaps in the suggested schedule. In the above example, the online concierge system 140 alternatively may identify 345 the suggested schedule for achieving the goal 410 as the suggested schedule including the fewest number of contiguous time slots 405 for which the online concierge system 140 has computed 340 a total estimated amount of earnings for the picker that is at least the target amount of earnings.

The online concierge system 140 may then send 350 (e.g., using the content presentation module 210) the suggested schedule identified 345 by the online concierge system 140 to the picker client device 110 associated with the picker (e.g., via the scheduling interface 400 described above). The suggested schedule may indicate the time slots 405 for which the picker is or is not suggested to work, the locations 420 and expected earnings for each time slot 405 for which the picker is suggested to work, and any other suitable types of information. Additionally, the suggested schedule may be sent 350 to the picker client device 110 in association with one or more estimated earnings for the picker (e.g., the picker's total estimated earnings, the picker's estimated earnings per hour, etc.). For example, as shown in FIG. 4C, which continues the example described above in conjunction with FIG. 4A, the suggested schedule 440 identified 345 for achieving the goal 410 of maximizing earnings for the picker is sent 350 in association with the total estimated earnings 430 for the picker and the estimated earnings per hour 435 for the picker. Alternatively, as shown in the example of FIG. 4D, which continues the example described above in conjunction with FIG. 4B, the suggested schedule 440 identified 345 for achieving the goal 410 of achieving an earnings target 425 is sent 350 in association with the total estimated earnings 430 for the picker and the estimated earnings per hour 435 for the picker.

In some embodiments, the suggested schedule 440 may be sent 350 to the picker client device 110 in association with a map generated by the online concierge system 140 (e.g., using the map generation module 280). In such embodiments, the map may indicate amounts of earnings associated with different locations 420 depicted in the map. In various embodiments, the map generated by the online concierge system 140 may correspond to a heat map, in which the amounts of earnings for different locations 420 depicted in the heat map are represented visually (e.g., with different colors, shades, etc.). In some embodiments, the online concierge system 140 may generate the map based on the estimated amount of earnings for each time slot-location pair computed 330 by the online concierge system 140. For example, based on information describing a time and a region including one or more locations 420 for which the picker is available to service orders placed with the online concierge system 140 received 305 from the picker client device 110 associated with the picker and the estimated amount of earnings for each time slot-location pair computed 330 by the online concierge system 140, the online concierge system 140 may generate a heat map. In this example, locations 420 associated with higher estimated amounts of earnings are shaded darker than locations 420 associated with lower estimated amounts of earnings. Furthermore, in some embodiments, the heat map may be interactive. In the above example, the heat map may be updated to indicate the estimated amount of earnings for pickers in a location 420 in response to receiving an interaction with the location 420 within the heat map from the picker client device 110. In alternative embodiments, the heat map may be generated based on an average amount of earnings associated with each location 420 depicted in the map. In the above example, based on order data (e.g., stored in the data store 240) describing amounts of earnings for pickers who serviced orders placed with the online concierge system 140 for the corresponding time slot-location pairs, locations 420 associated with higher average amounts of earnings are shaded darker than locations 420 associated with lower average amounts of earnings.

In embodiments in which the online concierge system 140 generates a heat map, the heat map may be presented in association with a schedule built by the picker. For example, as shown in FIG. 4E, suppose that the online concierge system 140 has received a request from the picker client device 110 for the picker to build their own schedule 445 via the scheduling interface 400 (rather than a request for the online concierge system 140 to generate a suggested schedule for the picker, as described above). In this example, suppose also that the online concierge system 140 has received information identifying a region 450 (San Francisco Bay Area) for which the picker is available to service orders placed with the online concierge system 140, availability information for the picker describing a day 455 (Monday) and hour of the day 460 (11) and a starting location 415 for the picker (San Francisco, CA) via the scheduling interface 400. In this example, the suggested schedule 440 may be sent 350 to the picker client device 110 via the scheduling interface 400 in association with a heat map 465. As shown in this example, the heat map 465 may be updated to indicate the estimated amount of earnings for pickers in San Francisco in response to receiving an interaction with this location 420 within the heat map 465 from the picker client device 110. In this example, the suggested schedule 440 also may be updated based on one or more inputs received from the picker client device 110 via the scheduling interface 400.

### Additional Considerations

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising, at a computer system comprising a processor and a computer-readable medium:
receiving, from a picker client device associated with a picker of an online concierge system, a goal associated with earnings for the picker and availability information for the picker, wherein the availability information describes a set of time slot-location pairs and each time slot-location pair corresponds to a time slot and a location for which the picker is available to service orders placed with the online concierge system;
accessing a first machine learning model that is trained to predict a likelihood that an order placed with the online concierge system will be available for the picker to service for a time slot-location pair;
applying the first machine learning model to predict the likelihood that an order placed with the online concierge system will be available for the picker to service for each time slot-location pair;
accessing a second machine learning model that is trained to predict an amount of earnings for the picker if the picker services an order placed with the online concierge system for a time slot-location pair;
applying the second machine learning model to predict the amount of earnings for the picker if the picker services an order placed with the online concierge system for each time slot-location pair;
for each time slot-location pair, computing an estimated amount of earnings for the picker based at least in part on the predicted likelihood and the predicted amount of earnings for a corresponding time slot-location pair;
generating a set of suggested schedules from the set of time slot-location pairs, wherein each suggested schedule comprises one or more time slot-location pairs of the set of time slot-location pairs;
for each suggested schedule, computing a total estimated amount of earnings for the picker based at least in part on the estimated amount of earnings and one or more costs for the picker associated with a corresponding suggested schedule;
identifying, from the set of suggested schedules, a suggested schedule for achieving the goal based at least in part on one or more selected from the group consisting of: the total estimated amount of earnings and an amount of time included in the suggested schedule; and
sending the suggested schedule to the picker client device.

2. The method of claim 1, wherein identifying the suggested schedule for achieving the goal is further based at least in part on a number of contiguous time slots included in the suggested schedule.

3. The method of claim 1, wherein the first machine learning model is trained by:
receiving a plurality of attributes associated with a plurality of time slot-location pairs, wherein the plurality of attributes describes a demand side, a supply side, and a set of supply gaps associated with the online concierge system;
receiving, for each of the plurality of time slot-location pairs, a label indicating whether an order placed with the online concierge system was available for a picker to service for a corresponding time slot-location pair; and
training the first machine learning model based at least in part on the plurality of attributes and the label for each of the plurality of time slot-location pairs.

4. The method of claim 1, wherein the second machine learning model is trained by:
receiving a plurality of attributes associated with a plurality of time slot-location pairs;
receiving, for each of the plurality of time slot-location pairs, a label indicating an amount of earnings for a picker who serviced an order placed with the online concierge system for a corresponding time slot-location pair; and
training the second machine learning model based at least in part on the plurality of attributes and the label for each of the plurality of time slot-location pairs.

5. The method of claim 1, wherein the suggested schedule is sent to the picker client device in association with the total estimated amount of earnings.

6. The method of claim 1, wherein the goal is selected from the group consisting of: a maximized amount of earnings and a target amount of earnings.

7. The method of claim 1, wherein the one or more costs are based at least in part on one or more selected from the group consisting of: a cost of fuel and a cost of a toll.

8. The method of claim 1, wherein generating the set of suggested schedules is based at least in part on a greedy partial enumeration algorithm.

9. The method of claim 8, wherein generating the set of suggested schedules comprises:
identifying one or more time slot-location pairs from the set of time slot-location pairs, wherein the estimated amount of earnings associated with each of the one or more time slot-location pairs is less than a threshold estimated amount of earnings; and
excluding the one or more time slot-location pairs from the set of suggested schedules.

10. The method of claim 1, further comprising:
generating a heat map based at least in part on the estimated amount of earnings for each time slot-location pair; and
sending the heat map to the picker client device, wherein sending the heat map to the picker client device causes the picker client device to display the heat map.

11. A computer program product comprising a non-transitory computer readable storage medium having instructions encoded thereon that, when executed by a processor, cause the processor to perform actions comprising:
receiving, from a picker client device associated with a picker of an online concierge system, a goal associated with earnings for the picker and availability information for the picker, wherein the availability information describes a set of time slot-location pairs and each time slot-location pair corresponds to a time slot and a location for which the picker is available to service orders placed with the online concierge system;
accessing a first machine learning model that is trained to predict a likelihood that an order placed with the online concierge system will be available for the picker to service for a time slot-location pair;
applying the first machine learning model to predict the likelihood that an order placed with the online concierge system will be available for the picker to service for each time slot-location pair;
accessing a second machine learning model that is trained to predict an amount of earnings for the picker if the picker services an order placed with the online concierge system for a time slot-location pair;
applying the second machine learning model to predict the amount of earnings for the picker if the picker services an order placed with the online concierge system for each time slot-location pair;
for each time slot-location pair, computing an estimated amount of earnings for the picker based at least in part on the predicted likelihood and the predicted amount of earnings for a corresponding time slot-location pair;
generating a set of suggested schedules from the set of time slot-location pairs, wherein each suggested schedule comprises one or more time slot-location pairs of the set of time slot-location pairs;
for each suggested schedule, computing a total estimated amount of earnings for the picker based at least in part on the estimated amount of earnings and one or more costs for the picker associated with a corresponding suggested schedule;
identifying, from the set of suggested schedules, a suggested schedule for achieving the goal based at least in part on one or more selected from the group consisting of: the total estimated amount of earnings and an amount of time included in the suggested schedule; and
sending the suggested schedule to the picker client device.

12. The computer program product of claim 11, wherein identifying the suggested schedule for achieving the goal is further based at least in part on a number of contiguous time slots included in the suggested schedule.

13. The computer program product of claim 11, wherein the first machine learning model is trained by:
receiving a plurality of attributes associated with a plurality of time slot-location pairs, wherein the plurality of attributes describes a demand side, a supply side, and a set of supply gaps associated with the online concierge system;
receiving, for each of the plurality of time slot-location pairs, a label indicating whether an order placed with the online concierge system was available for a picker to service for a corresponding time slot-location pair; and
training the first machine learning model based at least in part on the plurality of attributes and the label for each of the plurality of time slot-location pairs.

14. The computer program product of claim 11, wherein the second machine learning model is trained by:
receiving a plurality of attributes associated with a plurality of time slot-location pairs;
receiving, for each of the plurality of time slot-location pairs, a label indicating an amount of earnings for a picker who serviced an order placed with the online concierge system for a corresponding time slot-location pair; and
training the second machine learning model based at least in part on the plurality of attributes and the label for each of the plurality of time slot-location pairs.

15. The computer program product of claim 11, wherein the suggested schedule is sent to the picker client device in association with the total estimated amount of earnings.

16. The computer program product of claim 11, wherein the goal is selected from the group consisting of: a maximized amount of earnings and a target amount of earnings.

17. The computer program product of claim 11, wherein the one or more costs are based at least in part on one or more selected from the group consisting of: a cost of fuel and a cost of a toll.

18. The computer program product of claim 11, wherein generating the set of suggested schedules is based at least in part on a greedy partial enumeration algorithm.

19. The computer program product of claim 18, wherein generate the set of suggested schedules comprises:
identifying one or more time slot-location pairs from the set of time slot-location pairs, wherein the estimated amount of earnings associated with each of the one or more time slot-location pairs is less than a threshold estimated amount of earnings; and
excluding the one or more time slot-location pairs from the set of suggested schedules.

20. A computer system comprising:
a processor; and
a non-transitory computer readable storage medium storing instructions that, when executed by the processor, perform actions comprising:
receiving, from a picker client device associated with a picker of an online concierge system, a goal associated with earnings for the picker and availability information for the picker, wherein the availability information describes a set of time slot-location pairs and each time slot-location pair corresponds to a time slot and a location for which the picker is available to service orders placed with the online concierge system;
accessing a first machine learning model that is trained to predict a likelihood that an order placed with the online concierge system will be available for the picker to service for a time slot-location pair;
applying the first machine learning model to predict the likelihood that an order placed with the online concierge system will be available for the picker to service for each time slot-location pair;
accessing a second machine learning model that is trained to predict an amount of earnings for the picker if the picker services an order placed with the online concierge system for a time slot-location pair;
applying the second machine learning model to predict the amount of earnings for the picker if the picker services an order placed with the online concierge system for each time slot-location pair;
for each time slot-location pair, computing an estimated amount of earnings for the picker based at least in part on the predicted likelihood and the predicted amount of earnings for a corresponding time slot-location pair;
generating a set of suggested schedules from the set of time slot-location pairs, wherein each suggested schedule comprises one or more time slot-location pairs of the set of time slot-location pairs;
for each suggested schedule, computing a total estimated amount of earnings for the picker based at least in part on the estimated amount of earnings and one or more costs for the picker associated with a corresponding suggested schedule;
identifying, from the set of suggested schedules, a suggested schedule for achieving the goal based at least in part on one or more selected from the group consisting of: the total estimated amount of earnings and an amount of time included in the suggested schedule; and
sending the suggested schedule to the picker client device.
